(19) United States
(12) Patent Application Publication
(10) Pub. No.: US 2007/0214489 A1
(43) Pub. Date: Sep. 13, 2007

(54) Media presentation operations on computing devices

(76) Inventors: Wah Yiu Kwong, Beaverton, OR (US); Hong W. Wong, Portland, OR (US)

Correspondence Address: Caven & Aghevli LLC;c/o PortfolioIP, P.O. Box 52050, Minneapolis, MN, 55402, US

(21) Appl. No.: 11/370,765

(22) Filed: Mar. 8, 2006

(51) Int. Cl. H04N 7/16

(52) U.S. Cl. 725/135

(57) ABSTRACT

In one embodiment, an apparatus comprises a communication interface to receive a data stream comprising subtitle content, a translation module to translate the subtitle content from a first language to a second language, and a user interface to present the subtitle content.

### BACKGROUND

The subject matter described herein relates generally to the field of electronic communication and more particularly to media presentation operations on computing devices.

Many multi-media broadcast and recording formats, such as video formats, include subtitles. The subtitles may be encoded in a video stream, or may be encoded in a separate data stream. Subtitles present several issues. In some instances, subtitles may be presented in a language not spoken by one or more users of the viewing device. In other instances the subtitles may be too small to be readily visible, particularly if the viewing device has a small screen. In still other instances, subtitles may be presented on the screen at locations that interfere with video activity.

### BRIEF DESCRIPTION OF THE DRAWINGS

The detailed description is described with reference to the accompanying figures.

FIG. 1 is a schematic illustration of an exemplary computing device adapted to perform media presentation operations in accordance with an embodiment.

FIG. 2 is a flowchart illustrating media presentation operations performed in accordance with an embodiment.

FIG. 3 is a flowchart illustrating media presentation operations performed by the system of FIG. 1 in accordance with an embodiment.

FIG. 4 is a schematic illustration a computing device in accordance with an embodiment.

### DETAILED DESCRIPTION

Described herein are exemplary systems and methods for media presentation operations on computing devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

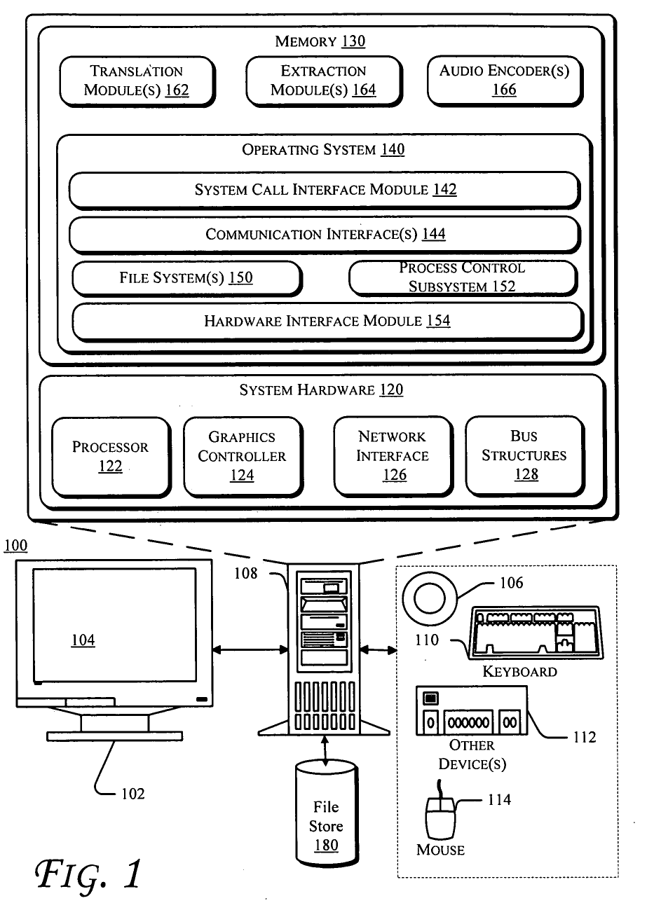

FIG. 1 is a schematic illustration of a system 100 adapted to perform media presentation operations according to an embodiment. In one embodiment, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, video controllers 124, network interfaces 126, and bus structures 128. In one embodiment, processor 122 may be embodied as an Intel® Pentium® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 124 may function as an adjunction processor that manages graphics and/or video operations. Graphics controller 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In various embodiments, the computing device 108 may be embodied as a personal computer, a laptop computer, a personal digital assistant, a mobile telephone, an entertainment device, or another computing device.

In one embodiment, memory 130 includes one or more translation modules 162 to translate subtitle content from a first language to a second language. In one embodiment, a translation module 162 may include commercially available language translation software such as, e.g., the TRANSLATE suite of products available from Language Engineering Company (LEC) of Belmont, Mass., USA. In alternate embodiments the translation module may be implemented as logic in a programmable logic circuit such as, e.g., a field programmable gate array (FPGA). The language service can also be provided by a service provider. The service provider can support “on-the-fly” translation services via network connection, such as wireless LAN, or cell phone networks while the image is displayed on the display 102.

Memory 130 may further include one or more extraction modules 164 to extract subtitle content from a data packet or a stream of data packets. In one embodiment, extraction module 164 utilizes optical character recognition (OCR) capabilities to extract subtitle content from a data packet or stream of data packets and one or more audio encoders 166 to encode electrical signals into audio signals.

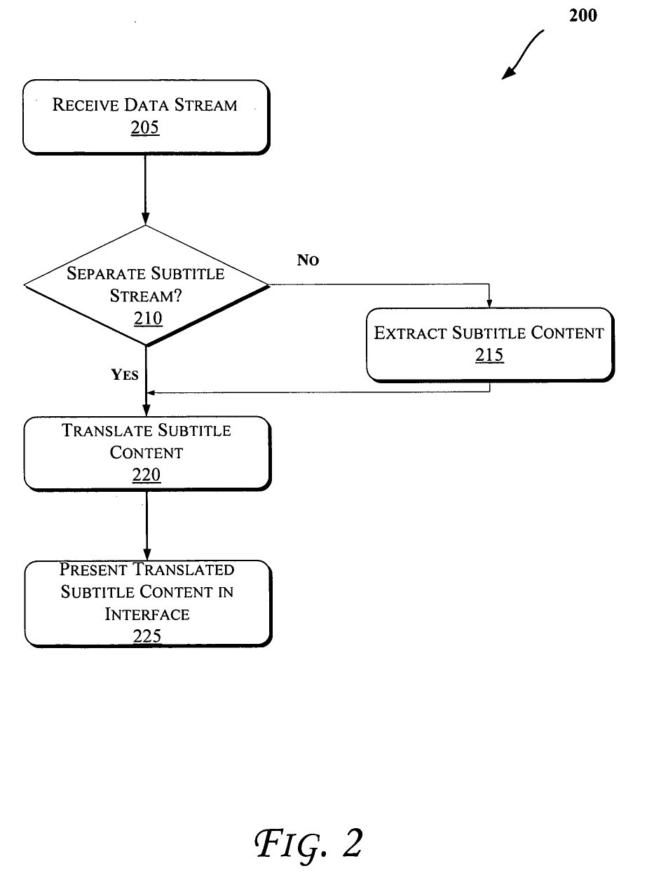

In one embodiment, system 100 translates subtitles from a first language to a second language. FIG. 2 is a flowchart illustrating media operations performed by system 100 in accordance with an embodiment. Referring to FIGS. 1-2, at operation 205 a data stream is received. In one embodiment, the data stream may be received from an external source such as, e.g., the Internet via a network interface 126. In an alternate embodiment, the data steam may be received from a media object such as, e.g., an object stored on a storage device such as, e.g., a magnetic drive, a CD-ROM, DVD-ROM, or the like.

If, at operation 210, the received data stream does not include a separate subtitle stream, then control passes to operation 215 and the subtitle content is extracted from the data stream. In the embodiment depicted in FIG. 1, the received data stream may be operated upon by one or more extraction modules 164. In one embodiment, the one or more extraction modules 164 may implement optical character recognition (OCR) capabilities to extract subtitle content from the data stream. By contrast, if the format of the received data stream allocates specific position(s) in the data stream to subtitle content, then the one or more extraction modules 164 may extract the subtitle content from the specific positions allocated in the data stream.

At operation 220, the subtitle content is translated from a first language to a second language. In the embodiment depicted in FIG. 1, the subtitle content may be operated upon by one or more translation modules 162. As illustrated in FIG. 2, if the subtitle content is in a separate data stream, then the subtitle content may be operated on directly by one or more translation modules 162. In one embodiment, system 100 may implement a delay to permit extraction and translation of subtitle content.

At operation 225 the translated subtitle content may be presented on an interface. The interface may include a display such as display 102 depicted in FIG. 1. In one embodiment, subtitle content may be presented on the display to enhance the visibility of the subtitle content. For example, subtitle content may be positioned at or near the bottom of the screen 104, and the background of the screen 104 may be presented in a color scheme that enhances the contrast between the subtitle content and the background. By way of example, the subtitle text may be presented in white or another light color, while the background may be set to black or another dark color.

In another embodiment, the translated subtitle content is presented to a user via an audio interface such as, e.g., via one or more speakers 106. In one embodiment, the translated subtitle content may be acted upon by one or more audio encoders 166 which convert the translated subtitle content into an audio signal. The audio signal may be presented to a user via speaker 106. In one embodiment, speaker 106 may be incorporated into a headphone.

In another embodiment, system 100 of FIG. 1 translates subtitles from one or more broadcast data streams. Existing analog formats broadcast subtitle content in screen lines outside the range of lines presented on the screen by conventional receiver. For example, the Line 21 captioning format uses the twenty-first line in the vertical blanking interval (VBI) of a video signal to carry subtitle content. Subtitle captioning content is encoded into line 21 of the VBI data signal and decoded at the receiver. The Digital Video Broadcast (DVB) format transmits subtitle content in a separate Packetized Elementary Stream (PES), which is synchronized with the broadcast data stream by the receiver.

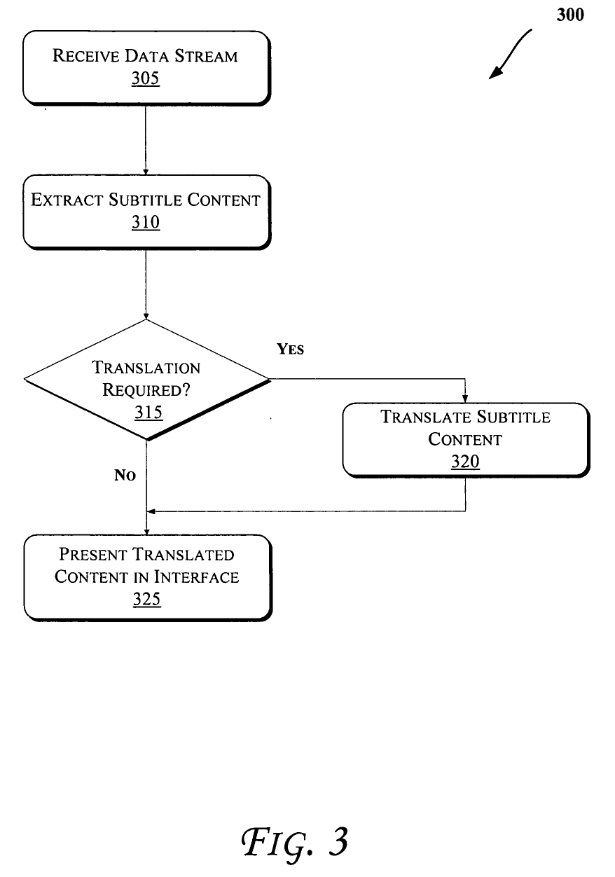

FIG. 3 is a flowchart illustrating media operations performed by system 100 of FIG. 1 in accordance with an embodiment. Referring to FIGS. 1-3, at operation 305 a data stream is received. In one embodiment, the data stream may be an analog or a digital broadcast data stream received via a network interface 126. In an alternate embodiment, the data steam may be received from a media object such as, e.g., a media object stored on a storage device such as, e.g., a magnetic drive, a CD-ROM, DVD-ROM, or other storage devices.

At operation, 310 the subtitle content may be extracted from the received data stream. For example, if the data stream is formatted in accordance with Line 21 subtitle formatting, then the one or more extraction modules 164 may extract the subtitle content from line 21 of the received signal. If the data stream is formatted in accordance with DVB formatting, then the one or more extraction modules may receive and decode the PES stream.

In one embodiment, the system 100 may receive user preferences via one or more of the input/output devices which specify whether subtitle content should be translated. If, at operation 315, translation of the subtitle content is not required, then control passes to operation 325 and the subtitle content is presented to a user interface. By contrast, if translation is required then at operation 320 the subtitle content is translated from a first language to a second language. In the embodiment depicted in FIG. 1, the subtitle content may be operated upon by one or more translation modules 162.

At operation 325, the subtitle content is presented to an interface. The interface may include a display such as display 102 depicted in FIG. 1. In one embodiment, subtitle content may be presented on the display to enhance the visibility of the subtitle content. For example, subtitle content may be positioned at or near the bottom of the screen 104, and the background of the screen 104 may be presented in a color scheme that enhances the contrast between the subtitle content and the background.

In another embodiment, the translated subtitle content is presented to a user via an audio interface such as, e.g., via one or more speakers 106. In one embodiment, the translated subtitle content may be acted upon by one or more audio encoders 166 which convert the translated subtitle content into an audio signal. The audio signal may be presented to a user via speaker 106. In one embodiment, speaker 106 may be incorporated into a headphone.

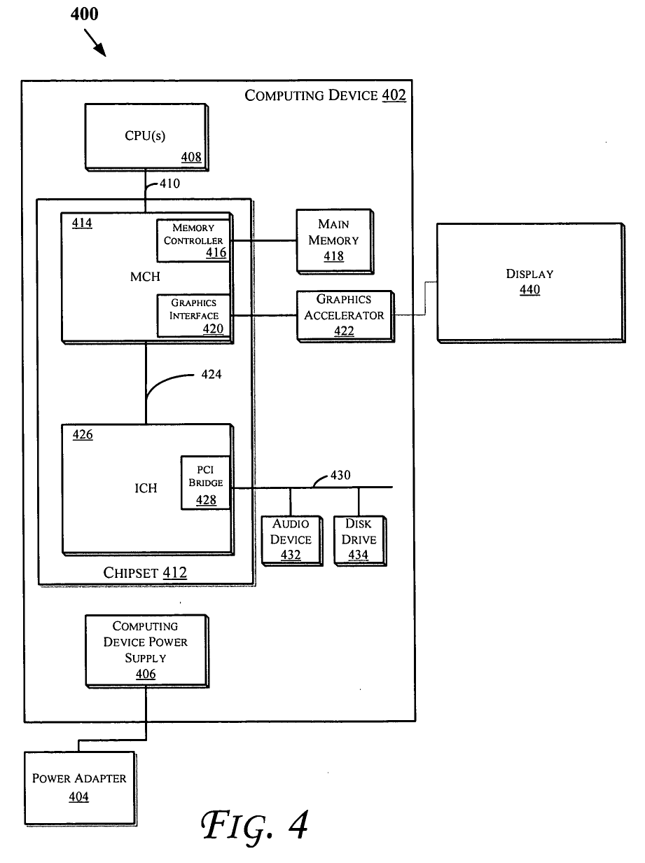

FIG. 4 is a schematic illustration of a computer system 400 in accordance with an embodiment. The computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In one embodiment, the power adapter 404 may transform the power supply source output (e.g., the AC outlet voltage of about 110 VAC to 240 VAC) to a direct current (DC) voltage ranging between about 7 VDC to 12.6 VDC. Accordingly, the power adapter 404 may be an AC/DC adapter.

The computing device 402 may also include one or more central processing unit(s) (CPUs) 408 coupled to a bus 410. In one embodiment, the CPU 408 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to the bus 410. The chipset 412 may include a memory control hub (MCH,) 414. The MCH 414 may include a memory controller 416 that is coupled to a main system memory 418. The main system memory 418 stores data and sequences of instructions that are executed by the CPU 408, or any other device included in the system 400. In one embodiment, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

The MCH 414 may also include a graphics interface 420 coupled to a graphics accelerator 422. In one embodiment, the graphics interface 420 is coupled to the graphics accelerator 422 via an accelerated graphics port (AGP). In an embodiment, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an input/output control hub (ICH) 426. The ICH 426 provides an interface to input/output (I/O) devices coupled to the computer system 400. The ICH 426 may be coupled to a peripheral component interconnect (PCI) bus. Hence, the ICH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to an audio device 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the ICH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 402 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a communication interface to receive a data stream comprising subtitle content;
a translation module to translate the subtitle content from a first language to a second language; and
an interface to present the subtitle content.

2. The apparatus of claim 1, wherein the subtitle content is embedded within the data stream.

3. The apparatus of claim 2, further comprising an extraction module to extract the subtitle content from the data stream.

4. The apparatus of claim 1, wherein the data stream comprises video content in a first data stream and subtitle content in a second data stream, different from the first data stream.

5. The apparatus of claim 1, wherein the interface comprises a display and the subtitle content is presented on the display.

6. The apparatus of claim 1, further comprising an audio encoder to convert the subtitle content into an audio signal.

7. The apparatus of claim 6, wherein the display comprises an audio interface to present the audio signal.

8. A method, comprising:
receiving a data stream comprising subtitle content;
translating the subtitle content from a first language to a second language; and
presenting the translated subtitle via a user interface.

9. The method of claim 8, wherein receiving a data stream comprising subtitle content comprises receiving multimedia content via a network interface.

10. The method of claim 8, wherein translating the subtitle content from a first language to a second language comprises extracting subtitle content from a video signal.

11. The method of claim 10, wherein extracting subtitle content from a video signal comprises using optical character recognition techniques.

12. The method of claim 10, wherein receiving a data stream comprising subtitle content comprises receiving separate video and subtitle data streams.

13. The method of claim 8, wherein presenting the translated subtitle via a user interface comprises presenting the translated subtitle on a display.

14. The method of claim 13, wherein presenting the translated subtitle on a display comprises presenting the subtitle on a designated portion of the display.

15. The method of claim 8, wherein presenting the translated subtitle via a user interface comprises converting the translated subtitle to and audio signal and presenting the audio signal to an audio interface.

16. A computer program product encoded on a computer readable medium comprising logic instructions which, when executed by a processor, configure the processor to:
receive a data stream comprising subtitle content;
translate the subtitle content from a first language to a second language; and
present the translated subtitle via a user interface.

17. The computer program product of claim 16, further comprising logic instructions which, when executed by a processor, configure the processor to extract subtitle content from a video signal.

18. The computer program product of claim 16, further comprising logic instructions which, when executed by a processor, configure the processor to use optical character recognition techniques.

19. The computer program product of claim 16, further comprising logic instructions which, when executed by a processor, configure the processor to present the translated subtitle on a display.

20. The computer program product of claim 16, further comprising logic instructions which, when executed by a processor, configure the processor to convert the translated subtitle to and audio signal and presenting the audio signal to an audio interface.

21. A system, comprising:
a storage device to store a data object including one or more data stream;
a communication interface communicatively coupled to the storage device to receive a data stream comprising subtitle content from the storage device;
a translation module to translate the subtitle content from a first language to a second language; and
a display module to display the subtitle content.

22. The system of claim 21, further comprising an extraction module to extract the subtitle content from the data stream.

23. The system of claim 21, further comprising an audio encoder to convert the subtitle content into an audio signal.
